(19) United States
(12) Patent Application Publication
(10) Pub. No.: US 2023/0243206 A1
(43) Pub. Date: Aug. 3, 2023

(54) INSULATING GLAZING UNIT AND GLAZING

(71) Applicant: SAINT-GOBAIN GLASS FRANCE, COURBEVOIE (FR)

(72) Inventors: Christian EFFERTZ, AACHEN (DE); Alicia DRÖGE, HERZOGENRATH (DE)

(21) Appl. No.: 17/928,158

(22) PCT Filed: Sep. 6, 2021
(86) PCT No.: PCT/EP2021/074449

§ 371 Date: Nov. 28, 2022

(30) Foreign Application Priority Data
Sep. 14, 2020 (EP) 20195897.2

(51) Int. Cl. E06B 3/663; G07C 3/00

(52) U.S. Cl. CPC E06B 3/66304; G07C 3/005

(57) ABSTRACT

An insulating glazing unit includes at least one spacer, which is shaped around the periphery to produce a spacer frame and delimits an inner region, a first glass pane, which is arranged on a pane contact surface of the spacer frame and a second glass pane, which is arranged on a second pane contact surface of the spacer frame, and the glass panes project beyond the spacer frame and an outer region is formed, which is filled, at least in some sections with a sealing element. At least one NFC transponder is arranged in the inner region, the NFC transponder includes an electronics unit, which is arranged on the inner surface of the spacer, and an antenna unit, which is arranged on the inner surface of one of the glass panes, and the electronics unit is electrically conductively connected to the antenna unit.

The invention relates to an insulating glazing unit, which has at least two glass panes and, therebetween, a spacer and sealing profile around the periphery near their edges, wherein at least one NFC transponder is arranged in the insulating glazing unit. The invention further relates to a glazing with a frame and an insulating glazing unit inserted into the frame insulating glazing unit, wherein the frame surrounds the edges of the insulating glazing unit. The glazing is, in particular, intended to form a façade glazing, a window, a door, or an interior partition with a corresponding structure.

Modern windows, doors, and façade glazings, at least for use in northern and temperate latitudes, are usually produced using prefabricated insulating glazing units (IGUs) that have the aforementioned structure, but, optionally, can include even more than two glass panes in the combination. Such insulating glazing units are mass-produced, shipped, and also independently marketed products that should be uniquely identifiable en route to an end product and possibly even during maintenance and servicing.

For identification, a plug connector for a spacer frame of a multipane insulating glazing unit can have a data transmitter with an electronic data memory, as is known from DE 20 2019 102 392 U1.

Furthermore, it is already known to provide insulating glazing units with identifying markings, for example, with “electronic” markings, such as RFID transponders that can be read by radio. Such insulating glazing units are disclosed, for example, in FR 2 787 135 A1, WO 00/36261 A1, or WO 2007/137719 A1. Furthermore, RFID transponders for marking solid and composite solid material panels are known from EP 2 230 626 A1.

Such an RFID transponder can be protected with a password such that it cannot be overwritten or its radio capability destroyed without considerable effort.

Insulating glazing units or glazings with RFID transponders have the disadvantage that a special reading device, which is expensive and usually reserved to the person skilled in the art, is necessary to read out the RFID transponder.

The object of the invention is, consequently, to provide an improved insulating glazing unit that enables simpler communication.

This object is accomplished according to a first aspect of the invention by a insulating glazing unit with the features of claim 1. Expedient further developments of the concept of the invention are the subject matter of the respective dependent claims.

The invention includes an insulating glazing unit, comprising:
at least one spacer, which is shaped around the periphery to produce a spacer frame and delimits an inner region,
a first glass pane, which is arranged on a pane contact surface of the spacer frame and a second glass pane, which is arranged on a second pane contact surface of the spacer frame, and
the glass panes project beyond the spacer frame and an outer region is formed, which is filled, at least in some sections, preferably entirely, with a sealing element,

wherein
at least one NFC transponder is arranged in the inner region,
the NFC transponder has an electronics unit, which is arranged on the inner surface of the spacer, and an antenna unit, which is arranged on the inner surface of one of the glass panes, wherein
the electronics unit is electrically conductively connected to the antenna unit.

Data are increasingly exchanged without contact in everyday life—for example, in contactless payment in the supermarket. Here, near field communication (NFC) is often used. The technology required for this is currently built into many bank and credit cards but also into NFC-capable transmitting and receiving devices such as smartphones, tablets, or the like, and is economical and widespread. Technically, NFC is a special form of RFID (radio-frequency identification), which functions only over short distances<10 cm, generally uses a frequency of 13.56 MHz, and can communicate in encrypted form.

However, this (short) readout distance requires that the antenna unit of the NFC transponder and the antenna of an NFC-capable transmitting and receiving device be optimality aligned with one another, preferably parallel. If an NFC transponder with an antenna unit is arranged on the inner surface of a spacer of an insulating glazing unit, as is already known in the prior art with UHF RFID transponders, these NFC transponders are virtually impossible to read with conventional NFC-capable transmitting and receiving devices.

Although a complete arrangement of the NFC transponder on the glass surface allows reading of the NFC transponder, the electronics unit of the NFC transponder is optically opaque and interferes with vision through the glass pane.

A remedy is provided by the separation according to the invention between an antenna unit that is designed to be optically transparent and not very conspicuous, and which can, consequently, be arranged on the glass surface and an electronics unit that is optically quite visible but can be positioned inconspicuously on the inner surface of the insulating glazing unit.

The insulating glazing unit according to the invention thus allows communication between the NFC transponder and widely available, economical NFC-capable transmitting and receiving devices such that a broad public—virtually anyone who has a smartphone with NFC technology—can use it.

In an advantageous embodiment of an insulating glazing unit according to the invention, the electronics unit is galvanically or capacitively connected to the antenna unit.

In another advantageous embodiment of an insulating glazing unit according to the invention, the antenna unit contains or consists of an antenna conductor. Antenna conductors according to the invention are matched in their dimensions and form to the frequencies commonly used in NFC and are familiar to the person skilled in the art. Conductor loops or coils of an electrical conductor are preferred. The antenna conductors are usually arranged in one plane and are suitable for communication with another NFC antenna, likewise arranged in one plane. As a rule and in undisturbed systems, optimum signal transmission occurs when the two antenna planes are oriented as parallel as possible to one another and the antennas are aligned congruently.

In another advantageous embodiment of an insulating glazing unit according to the invention, the antenna conductor contains or consists of a thin metallic or metal structure, preferably a wire and particularly preferably a wire with external insulation, or a print of an electrically conductive paste. Such wires have, for example, a diameter from 5 μm to 500 μm, preferably 10 μm to 100 μm and are made, for example, of copper, aluminum, or silver. Such wires or prints are hardly visible to the human eye and only slightly impair vision through the insulating glazing unit.

In another advantageous embodiment of an insulating glazing unit according to the invention, the antenna conductor is arranged on a carrier element such as a carrier film or a rigid carrier plate that is transparent in the visible wavelength range.

In the context of the present invention, “transparent in the visible wavelength range” means that the transmittance for wavelengths between 380 nm and 750 nm is more than 80%, preferably more than 90%, and in particular more than 96%.

The carrier element is preferably made of a dielectric material. Particularly advantageous in this regard is a single-ply or multi-ply polymer film, particularly preferably made of polyethylene terephthalate (PET) or polyimide. Such polymer films preferably have a thickness from 20 μm to 800 μm, preferably between 50 μm and 200 μm.

In another advantageous embodiment of an insulating glazing unit according to the invention, the electronics unit contains or consists of an NFC circuit. In another advantageous embodiment of an insulating glazing unit according to the invention, the NFC circuit is arranged on a carrier element such as a carrier film or a rigid carrier plate. The carrier element is preferably made of a dielectric material. Particularly advantageous in this regard is a single-ply or multi-ply polymer film, particularly preferably made of polyethylene terephthalate (PET) or polyimide or of rigid printed circuit board material, for example, of FR4. Such carrier elements preferably have a thickness from 50 μm to 800 μm, preferably between 100 μm and 600 μm. Thin polymer films have the particular advantage that they are flexible and can thus be easily adapted to the conditions of the substrate and can also be easily kinked or folded.

Advantageous spacers according to the invention often consist of a desiccant-filled hollow profile that is made of metal or is coated with a metal foil or metallized foil at least in some sections.

Alternative advantageous spacers according to the invention often consist of a polymer body that is preferably coated only on the outer surface with a metallic or metallized foil. In the case of such a spacer, which is electrically insulating on the contact surface of the electronics unit, the carrier element can be designed correspondingly thinner or can be omitted.

The radio wavelengths used in NFC transponder systems according to the invention are usually, depending on the type, in the range from 13.50 MHz to 13.60 MHz and in particular at 13.56 MHz.

Radio signals with these frequencies penetrate both wood and conventional plastics, but not metals. In particular, when the electronics unit or the leads to the antenna are arranged directly on a metallic spacer or on a metallic or metallized foil on the inner surface of the spacer, this can lead to a high-frequency short-circuit of the antenna unit and thus to undesirable impairment of the NFC transponder.

Consequently, in a preferred embodiment of the NFC transponder, the electronics unit and the leads to the antenna conductor are arranged on a dielectric carrier element, particularly preferably a polymeric carrier element. The thickness of the carrier element is adapted to the material and, in particular, to the dielectric constant of the carrier element and is preferably from 0.2 mm to 5 mm, preferably 0.5 mm to 2 mm.

It goes without saying that the antenna unit together with the electronics unit per se can be arranged on a common carrier film or carrier plate, significantly simplifying assembly and prefabrication.

The carrier elements can also be rigid carrier plates that have a fixed angle of approx. 90° relative to one another or are connected to one another by a flexible section in the area of curvature between the rigid carrier plates.

In another advantageous embodiment of an insulating glazing unit according to the invention, the electronics unit is connected to the inner surface of the spacer via an adhesive surface. It is particularly advantageous with all antenna units that are not already fixedly connected to the glass pane for technical reasons for the antenna unit to be likewise connected to the glass pane via an adhesive surface. Adhesives that are transparent in the visible wavelength range when dry are preferred. Fastening via adhesive surfaces ensures positioning and fixing in the insulating glazing unit that is secure for transport and use.

In another advantageous embodiment of an insulating glazing unit according to the invention, an electrically conductive coating that is transparent in the visible wavelength range is arranged on the inner surface of at least one of the glass panes. Such coatings are well-known as infrared reflecting or infrared absorbing solar protection coatings.

Such a solar protection coating preferably includes at least one thin transparent metallic layer that is embedded between at least one dielectric layer on each side. Silver has established itself as the preferred metal for the metallic layer since it both has a relatively neutral color effect and selectively reflects the infrared radiation outside the visible range of solar radiation. The dielectric layers have the function of improving the optical properties of the coated pane via their refractive indices and of protecting the metallic functional layer against oxidation. Such solar protection layers, which can, for example, be produced by the reactive sputtering method, are used extensively in glazings for buildings, but also already in motor vehicles. In most cases, layer systems with two silver functional layers but also with three or four silver functional layers are used since their efficiency level, i.e., the reflection of infrared radiation outside the visible range in relation to the transmittance of visible radiation, is greater. Suitable solar protection coatings are known, for example, from WO2013/104439A1 and from DE 19927683C1. The dielectric layers are preferably based on dielectric oxides or nitrides, such as ZnO, SnZnO, AlN, SiO₂, TiO₂, or Si₃N₄.

In principle, however, all coatings that are electrically conductive and transparent in the visible wavelength range are suitable.

Advantageous coatings have electrical resistance of less than 100 ohm/square, particularly preferably of less than 5 ohm/square and in particular of 0.5 ohm/square to 2 ohm/square.

Such coatings can, for example, be removed in sections by laser decoating or mechanical or chemical methods, thus creating electrically insulating sections. In a preferred embodiment, the antenna conductor according to the invention contains or consists of a structure delimited by local stripping of the coating, preferably by laser decoating. Such decoatings can be produced with low line widths from 80 μm to 200 μm, typically 100 μm, and are hardly perceptible to the human eye.

Alternatively or in combination, the antenna conductor according to the invention can contain or consist of an imprint on the inner surface of the glass panes that is electrically conductive and preferably transparent in the visible wavelength range. The imprint can contain or consist of, for example, silver-containing inks or pastes, graphene-containing inks or pastes, inks or pastes with nanoparticles, in particular so-called “carbon nanotubes”, or transparent inks based on organic conductive molecules, e.g., the molecule PEDOT:PSS.

In another advantageous embodiment of an insulating glazing unit according to the invention, the electronics unit is electrically conductively connected, preferably galvanically or capacitively, to the antenna conductor arranged directly on the glass pane via a contact region having at least two contact surfaces.

In another advantageous embodiment of an insulating glazing unit according to the invention, the NFC transponder has or is connected to at least one sensor for measuring temperature, pressure, moisture, heat flow, electromagnetic radiation, preferably in the visible wavelength range and/or in the infrared range or UV range, and/or for detecting.

Another aspect of the invention includes a glazing, in particular a façade glazing, a window, a door, or an interior partition, comprising a frame, and an insulating glazing unit according to the invention arranged in the frame.

In another advantageous embodiment of a glazing according to the invention, the frame surrounds the end faces of the insulating glazing unit and, at the same time, covers the electronics unit in the through-vision direction (Arrow A) through the glass panes, with the top view of the antenna conductor remaining possible. This has the particular advantage that the electronics unit is even better concealed and is visually even less conspicuous.

In another advantageous embodiment of a glazing according to the invention, the frame contains or consists of a metallic first frame element, a metallic second frame element, and a polymeric third frame element connecting the frame elements at least in some sections and particularly preferably completely around the periphery. The polymeric frame element significantly reduces heat transfer from the first frame element to the second frame element and thus, for example, from an exterior side to an interior side.

Elastomer profiles that seal the glazing and fix the glass panes can be arranged between the exterior sides of the glass panes and the interior sides of the adjacent preferably metallic, frame elements.

It goes without saying that, by simple experiments, the person skilled in the art can find designs and positions with advantageous transmission and reception properties. The exemplary embodiments and aspects mentioned here are consequently primarily recommendations for the person skilled in the art, without restricting the implementation possibilities of the invention.

Thus, it goes without saying that an insulating glazing unit can have a plurality of NFC transponders, in particular on the inner surfaces of the spacers of the different sides (top, bottom, right, left) of the insulating glazing unit.

Another aspect of the invention relates to a system comprising,
an insulating glazing unit according to the invention or a glazing according to the invention, and
an NFC transmitting and/or receiving device arranged outside the insulating glazing unit or the glazing for transmitting and/or receiving data, preferably identification data or sensor data, from the insulating glazing unit or the glazing to the outside or from the outside into the insulating glazing unit (1) or the glazing,

The NFC transmitting and/or receiving unit according to the invention is preferably a mobile terminal such as a mobile phone, smartphone, or tablet.

The invention makes it possible to communicate with the NFC transponder with a commercially available NFC-capable transmitting and/or receiving device (mobile terminal), such as a smartphone, tablet, or the like. For this purpose, for example, the NFC-capable transmitting and/or receiving device is held with its NFC antenna plane (usually parallel to the back of the housing) parallel to the glass panes above the antenna unit. The distance between the NFC-capable transmitting and/or receiving device and the antenna unit is typically less than 10 cm. Advantageously, the NFC-capable transmitting and/or receiving device is held directly against the outer side of the glass pane.

As already explained at the outset, the antenna conductors according to the invention are usually arranged in one plane and are suitable for communicating with another NFC antenna, which is likewise arranged in one plane. Generally and in undisturbed systems, optimum signal transmission takes place when the two antenna planes are aligned as parallel as possible to one another and the antennas are aligned congruently.

Another aspect of the invention includes a computer program product which is executed on the NFC-capable transmitting and/or receiving device (front-end software) and/or on a server (back-end software) connected via mobile radio to the NFC-capable transmitting and/or receiving device. The computer program product is suitable for identification of an insulating glazing unit according to the invention or of a glazing according to the invention and/or for reading out sensors in the insulating glazing unit according to the invention or the glazing according to the invention.

The computer program product is, in particular, an application for mobile terminals.

Another aspect of the invention includes the use of an NFC transponder in an insulating glazing unit according to the invention or in a glazing according to the invention as an identification element or for reading out sensors connected to the NFC circuit.

Advantages and functionalities of the invention are also evident from the following description of exemplary embodiments and aspects of the invention with reference to the figures. The drawings are purely schematic representations and not to scale. They in no way restrict the invention. They depict:

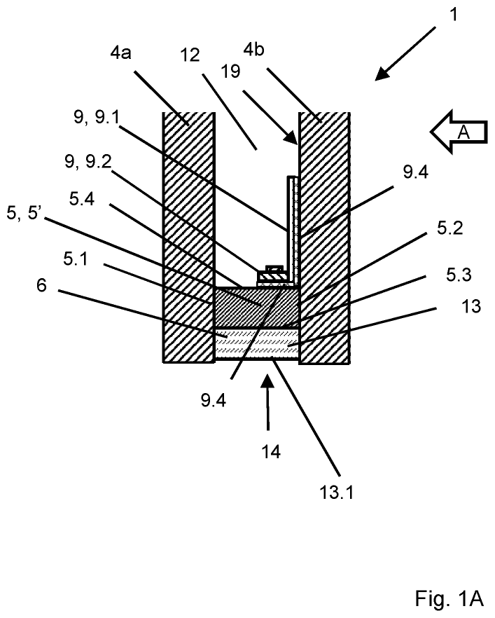

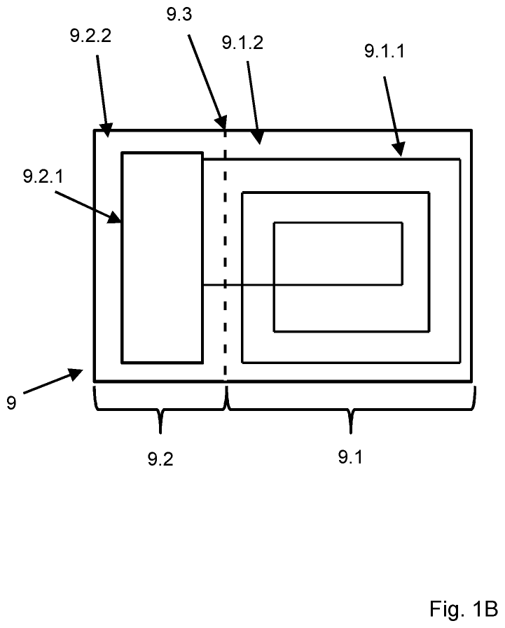

FIG. 1A a detailed view (cross-sectional representation) of an edge region of an insulating glazing unit in accordance with an embodiment of the invention,

FIG. 1B a plan view of an NFC transponder according to the invention in accordance with the embodiment of the invention of FIG. 1A,

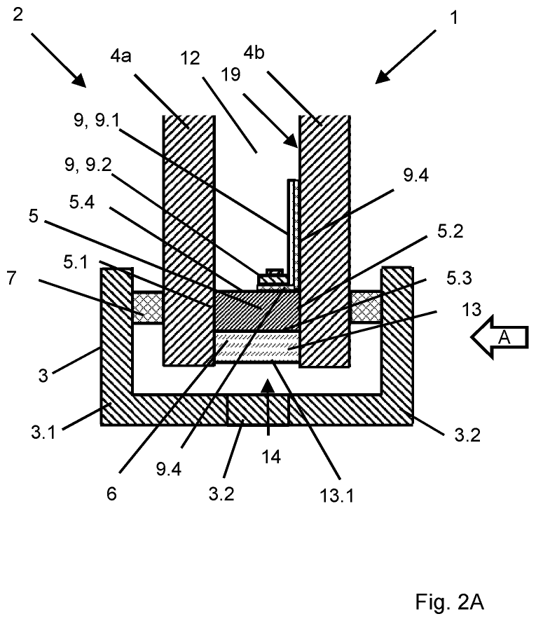

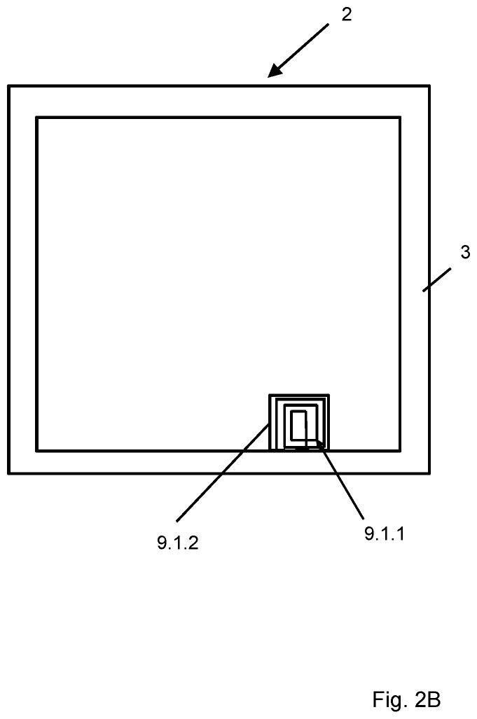

FIG. 2A a detailed view (cross-sectional representation) of an edge region of a glazing with an insulating glazing unit in accordance with an embodiment of the invention,

FIG. 2B a plan view auf a glazing according to the invention in accordance with the embodiment of the invention of FIG. 2A,

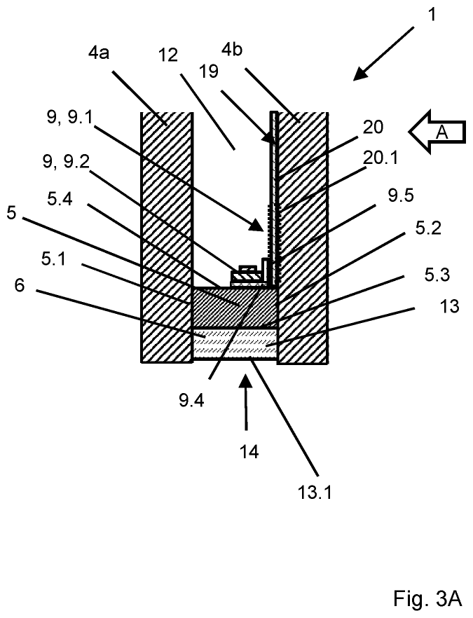

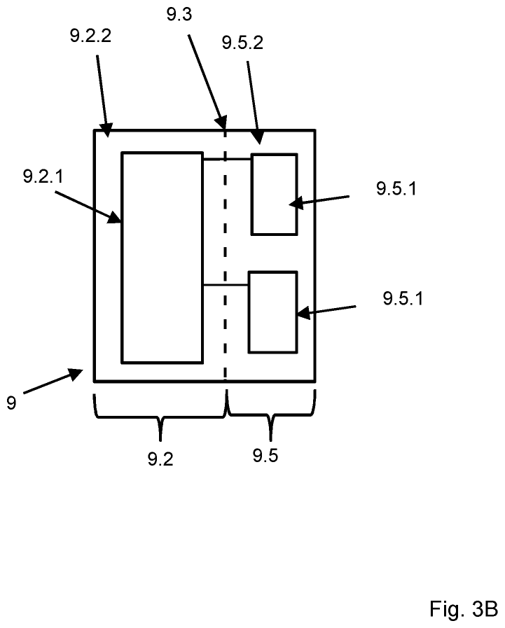

FIG. 3A a detailed view (cross-sectional representation) of an edge region of an insulating glazing unit in accordance with an alternative embodiment of the invention,

FIG. 3B a plan view of an NFC transponder according to the invention in accordance with the embodiment of the invention of FIG. 3A.

In the figures as well as the following description, the insulating glazing units as well as the glazings and the individual components are in each case identified with the same or similar reference numbers, regardless of the fact that the specific embodiments differ.

FIG. 1A depicts an edge region of an insulating glazing unit 1 in cross-section. The insulating glazing unit 1 comprises, in this embodiment, two glass panes 4a and 4b. These are held apart at a predetermined distance by a spacer 5 placed between the glass panes 4a, 4b near the end face 14 of the insulating glazing unit 1. The main body of the spacer 5 is made, for example, of glass-fiber-reinforced styrene acrylonitrile (SAN).

Multiple spacers 5 (here, for example, four) are routed along the side edges of the glass panes 4a, 4b and form a spacer frame 5′. The pane contact surfaces 5.1, 5.2 of the spacers 5, i.e., the contact surfaces of the spacers 5 with the glass panes 4a, 4b, are bonded in each case to the glass panes 4a or 4b and thus mechanically fixed and sealed. The adhesive bond consists, for example, of polyisobutylene or butyl rubber. The inner surface 5.4 of the spacer frame 5′ delimits, together with the glass panes 4a, 4b, an inner region 12.

The spacer 5 is usually hollow (not shown) and filled with a desiccant (not shown), which binds, via small interior-side openings (likewise not shown), any moisture that has penetrated into the inner region 12. The desiccant contains, for example, molecular sieves such as natural and/or synthetic zeolites. The inner region 12 between the glass panes 4a and 4b is filled, for example, with a noble gas, such as argon.

The glass panes 4a, 4b usually project beyond the spacer frame 5′ on all sides such that the outer surface 5.3 of the spacer 5 and the outer sections of the glass panes 4a, 4b form an outer region 13. A sealing element (sealing profile) 6 is introduced into this outer region 13 of the insulating glazing unit 1 between the glass panes 4a and 4b and outside the spacer 5. This is shown here in simplified form as a single piece. In practice, it usually comprises two components, one of which seals the contact surface between the spacer 5 and the glass panes 4a, 4b and protects against penetrating moisture and external influences. The second component of the sealing element 6 additionally seals and mechanically stabilizes the insulating glazing unit 1. The sealing element 6 is, for example, formed from an organic polysulfide.

An insulation film (not shown here), which reduces the heat transfer through the polymeric spacer 5 into the inner region 12, is applied, for example, on the outer surface 5.3 of the spacer 5, i.e., on the side of the spacer 5 facing the outer region 13. The insulation film can, for example, be attached to the polymeric spacer 5 with a polyurethane hot-melt adhesive. The insulation film contains, for example, three polymeric layers of polyethylene terephthalate with a thickness of 12 μm and three metallic layers made of aluminum with a thickness of 50 nm. The metallic layers and the polymeric layers are attached alternatingly in each case, with the two outer plies formed by polymeric layers. In other words, the layer sequence consists of a polymeric layer, followed by a metallic layer, followed by an adhesive layer, followed by a polymeric layer, followed by a metallic layer, followed by an adhesive layer, followed by a metallic layer, followed by a polymeric layer.

As already mentioned, the main body of the spacer 5 is made, for example, of glass-fiber-reinforced styrene acrylonitrile (SAN). By means of the selection of the glass fiber content in the spacer main body, its coefficient of thermal expansion can be varied and adjusted. By adjusting the coefficient of thermal expansion of the spacer main body and of the insulation film, temperature-induced stresses between the different materials and flaking of the insulation film can be avoided. The spacer main body has, for example, a glass fiber content of 35%. The glass fiber content in the spacer main body simultaneously improves strength and stability.

The first glass pane 4a and the second glass pane 4b are made, for example, of soda lime glass with a thickness of 3 mm and have, for example, dimensions of 1000 mm×1200 mm. It goes without saying that each insulating glazing unit 1 depicted in this and the following exemplary embodiments can also have three or more glass panes.

The insulating glazing unit 1 has, for example, an NFC transponder 9. The NFC transponder 9 according to the invention consists of an antenna unit 9.1 and an electronics unit 9.2. The electronics unit 9.2 is, for example, connected to the inner surface 5.4 of the spacer 5 via an adhesive surface 9.4, and is attached thereon. The antenna unit 9.1 is arranged orthogonally to the electronics unit 9.2 and thus orthogonally to the inner surface 5.4 of the spacer 5. The antenna unit 9.1 is thus arranged parallel to the second glass pane 4b and connected thereto, for example, via an adhesive surface 9.4. The adhesive of the adhesive surface 9.4 is advantageously optically transparent at least in the region of the connection to the glass pane 4b, in particular in the visible wavelength range.

FIG. 1B depicts a schematic plan view of a simplified representation of an NFC transponders 9 according to the invention. In this simplified representation, the antenna unit 9.1 and the electronics unit 9.2 are shown in one plane. This corresponds, for example, to the NFC transponder 9 prior to assembly in the insulating glazing unit 1. During assembly, the NFC transponder 9 is kinked along the curvature line 9.3 such that the planar regions of the antenna unit 9.1 and of the electronics unit 9.2 are orthogonal to one another.

The electronics unit 9.2 consists here, for example, of an NFC circuit 9.2.1 that is arranged on a carrier film 9.2.2. The carrier film 9.2.2 is, for example, a PET film with a thickness of 170 μm.

In this example, the antenna unit 9.1 consists of an antenna conductor 9.1.1 that is arranged on a carrier film 9.1.2. The antenna conductor 9.1.1 is made, for example, from a very thin wire that is hardly detectable visually, for example, with a thickness of 10 μm. Alternatively or in combination, the antenna conductor 9.1.1 can be made of a thin electrically conductive imprint on the carrier film 9.1.2. Advantageously, the imprint itself is optically transparent.

The antenna conductor 9.1.1 is tuned to the operating frequency of the electronics unit 9.2, is, for example, at 13.56 MHz.

The carrier film 9.1.2 is made, for example, from an ultrathin PET film, for example, with a thickness of 50 μm. Advantageously, the carrier film 9.1.2 is optically transparent.

The carrier film 9.1.2 the antenna unit 9.1 is fixedly connected to the carrier film 9.2.2 of the electronics unit 9.2, for example, by being formed in one piece in sections. The carrier film 9.2.2 can then be implemented multi-ply and thus thickened in the region of the electronics unit 9.2, for example.

The antenna conductor 9.1.1 can have any form suitable for transmitting and receiving NFC signals. For example, the antenna conductor 9.1.1 has the form of a multi-wound conductor loop that is arranged in one plane. This plane is arranged parallel to the glass panes 4a, 4b in the installed position of the insulating glazing unit 1.

This makes it possible to communicate with the NFC transponder 9 with a commercially available NFC-capable transmitting and/or receiving device (mobile terminal), such as a smartphone, tablet, or the like. For this, for example, the NFC-capable receiving and/or transmitting device is held with its antenna plane parallel to the glass panes 4a, 4b above the antenna unit 9.1. The distance between the NFC-capable receiving and/or transmitting device and the antenna unit 9.1 is typically less than 10 cm. Advantageously, the NFC-capable receiving and/or transmitting device is held directly against the outer side 18 of the glass pane 4b and congruently with the antenna conductor 9.1.1.

With a corresponding computer program product that is executed on the NFC-capable transmitting and/or receiving device (front-end software) and/or on a server (back-end software) connected via mobile radio to the NFC-capable receiving and transmitting device.

FIG. 2A depicts a detailed view (cross-sectional representation) of an edge region of a glazing 2 with an insulating glazing unit 1 of FIGS. 1A and 1B.

FIG. 2B depicts a plan view of the glazing 2 with insulating glazing unit 1 of FIG. 2A with a viewing direction according to the Arrow A of FIG. 2A.

FIGS. 2A and 2B show views of the insulating glazing unit 1 of FIGS. 1A and 1B, as they can be, for example, arranged within a glazing 2. For details concerning the insulating glazing unit 1, reference is therefore made to the description of FIGS. 1A and 1B.

Furthermore, a, for example, U-shaped frame 3 surrounds the edges of the insulating glazing unit 1 together with the electronics unit 9.2 of the NFC transponder 9.

It goes without saying that the frame 3 can be configured as desired. The frame 3 can, for example, consist of a U-shaped metallic or nonmetallic profile.

In this example, the frame 3 also includes a first metallic frame element 3.1 that is connected to a second metallic frame element 3.2 via a polymeric, electrically insulating third frame element 3.3. In this example, the first and second frame elements 3.1, 3.2 are L-shaped. Consequently, the frame 3 surrounds the end face 14 of the insulating glazing unit 1 in the shape of a U. The sections of the first and second frame elements extending parallel to the large surfaces of the glass panes 4a, 4b are implemented such that they completely cover at least the outer region 13 with the sealing element 6 and the spacer frames 5′ in the through-vision direction (arrow A)

The insulating glazing unit 1 is arranged on carriers (not shown here), in particular on plastic carriers or carrier elements electrically insulated by plastics. Furthermore, an elastomer profile 7 is arranged in each case between the metallic frame elements 3.1, 3.2 and the glass panes 4a, 4b such that the insulating glazing unit 1 is firmly held within the frame 3. The elastomer profile 7 has, for example, a thickness of 6.5 mm and fixes the distance between the respective frame elements 3.1, 3.2 and the glass panes 4a, 4b.

The frame 3 also obscures, in particular, the view of the NFC electronics 9.2 when viewed through the glazing 2. However, the frame 3 does not obscure the view of or through the antenna unit 9.1. This is hardly perceptible optically because they consist only of components that are hardly perceptible optically, such as very thin antenna conductors 9.1.1 and optically transparent carrier film 9.1.2 and are bonded to the glass pane 4b by an adhesive surface 9.4 made of an optically transparent adhesive.

As a result of the undisturbed signal path for electromagnetic radiation in the NFC range (here 13.56 MHz) between the antenna unit 9.1 and the outer region of the glazing 2, the NFC transponder 9 can communicate undisturbed with an NFC-capable transmitting and/or receiving device.

FIG. 3A depicts a detailed view (cross-sectional representation) of an edge region of a glazing 2 with an insulating glazing unit 1 in accordance with another embodiment of the invention. The insulating glazing unit 1 and the NFC transponder 9 correspond essentially to the exemplary embodiment of FIGS. 1A and 1B such that in the following, only the differences will be discussed.

In this example, the inner surface 19 of the glass pane 4b facing the interior 12 has an electrically conductive coating 20 that is transparent in the visible wavelength range. Such coatings 20 are in particular suitable for reflecting or absorbing IR radiation and thus avoiding undesired heating or undesired cooling of an interior.

In this example, the antenna unit 9.1 comprises an antenna conductor 9.1.1, introduced into a region 20.1 of the coating 20, for example, by laser decoating. For example, a conductor loop can be produced by electrically insulating the outer contours by laser decoating of thin lines in the transparent, electrically conductive coating 20. The thin decoated lines have, for example, a width of 100 μm and are hardly perceptible to the human eye.

FIG. 3B shows a schematic plan view of a simplified representation of an NFC transponders 9 according to the invention for such an application. Analogously to FIG. 1B, the NFC transponder 9 in FIG. 3B has an electronics unit 9.2 consisting of an NFC circuit 9.2.1 that is arranged on a carrier film 9.2.2. In this exemplary embodiment, the carrier film 9.2.2 is connected to a contact region 9.5. The contact region 9.5 contains a carrier film 9.5.2 on which, here, for example, two contact surfaces 9.5.1 are arranged. The contact surfaces 9.5.1 are arranged on the side of the carrier film 9.5.2 facing away from the NFC circuit 9.2.1. The contact surfaces 9.5.1 are electrically conductively connected to the NFC circuit 9.2.1 via electrical leads. Analogously to FIG. 1B, the NFC transponder 9 is folded along the curvature line 9.3.

Here, the electronics unit 9.2 is likewise arranged on the inner surface 5.4 of the spacer 5 via an adhesive surface 9.4. The contact surfaces 9.5.1 are parallel to the inner surface 19 of the glass pane 4b and are electrically conductively connected, preferably galvanically or capacitively, to the antenna conductor 9.1.1 in the transparent, electrically conductive coating 20.

In an embodiment not shown here of an insulating glazing unit 1 according to the invention, the antenna conductor 9.1.1 is printed on the inner surface 19 of one of the glass panes 4a, 4b or applied in another form, for example, by gluing a thin wire directly onto the glass pane 9.4. Here, the antenna conductor 9.1.1. is likewise preferably transparent or so thin that it is hardly perceptible visually. Such antenna conductors 9.1.1 can also be contacted particularly well to an arrangement according to FIG. 3B via contact surfaces 9.5.1.

It goes without saying that in all exemplary embodiments mentioned, the carrier films 9.2.2 of the electronics unit 9.1 can be formed in one piece or in multiple pieces with the carrier films 9.1.2 of the antenna unit 9.1 or the carrier films 9.5.2 of the contact region 9.5. It also goes without saying that one or all carrier films can also be of corresponding thickness or formed as carrier plates that are flexibly connected to one another, in particular in the region of the curvature line 9.3.

The practice of the invention is not limited to the examples and highlighted aspects of the embodiments, but is also possible in a large variety of modifications apparent to the person skilled in the art from the appended claims.

### LIST OF REFERENCE CHARACTERS

1 insulating glazing unit
2 glazing
3 frame
3.1,3.2 metallic, first or second frame element
3.3 polymeric, third frame element
4a, 4b glass panes
5 spacer
5′ spacer frame
5.1,5.2 pane contact surface
5.3 outer surface of the spacer 5
5.4 inner surface of the spacer 5
6 sealing element
7 elastomer profile
9 NFC transponder
9.1 antenna unit
9.1.1 antenna conductor
9.1.2 carrier film
9.2 electronics unit
9.2.1 NFC circuit
9.2.2 carrier film
9.3 curvature line
9.4 adhesive surface
9.5 contact region
9.5.1 contact surface
9.5.2 carrier film
12 inner region
13 outer region
14 end face of the insulating glazing unit 1 or the glass panes 4a, 4b
18 outer surface of the glass pane 4a or 4b
19 inner surface of the glass pane 4a or 4b
20 transparent, electrically conductive coating
20.1 region of the coating 20
Arrow A top view direction or through-vision direction

1. An insulating glazing unit, comprising:
at least one spacer, which is shaped around a periphery to produce a spacer frame and delimits an inner region,
a first glass pane, which is arranged on a pane contact surface of the spacer frame and a second glass pane, which is arranged on a second pane contact surface of the spacer frame, and
the first and second glass panes project beyond the spacer frame and an outer region is formed, which is filled, at least in some sections with a sealing element,
wherein
at least one NFC transponder is arranged in the inner region,
the NFC transponder comprises an electronics unit, which is arranged on the inner surface of the spacer, and an antenna unit, which is arranged on the inner surface of one of the glass panes, and
the electronics unit is electrically conductively connected to the antenna unit.

2. The insulating glazing unit according to claim 1, wherein the antenna unit contains or consists of an antenna conductor.

3. The insulating glazing unit according to claim 2, wherein the antenna conductor contains or consists of a thin electrically conductive structure.

4. The insulating glazing unit according to claim 2, wherein the antenna conductor is arranged on a carrier film or a rigid carrier plate.

5. The insulating glazing unit according to claim 1, wherein the electronics unit contains or consists of an NFC circuit.

6. The insulating glazing unit according to claim 5, wherein the NFC circuit is arranged on a rigid carrier plate or a carrier film.

7. The insulating glazing unit according to claim 1, wherein the electronics unit is connected to the spacer via an adhesive surface.

8. The insulating glazing unit according to claim 1, wherein an electrically conductive coating transparent in the visible wavelength range is arranged on the inner surface of at least one of the first and second glass panes, and the antenna conductor contains or consists of a structure delimited by local stripping of the coating.

9. The insulating glazing unit according to claim 1, wherein the antenna conductor is an electrically conductive imprint on the inner surface of the first and second glass panes.

10. The insulating glazing unit according to claim 8, wherein the electronics unit is electrically conductively connected to the antenna conductor arranged directly on the at least one of the first and second glass panes via a contact region having at least two contact surfaces.

11. The insulating glazing unit according to claim 1, wherein the NFC transponder has an operating frequency of 13.50 MHz to 13.60 MHz.

12. The insulating glazing unit according to claim 1, wherein the NFC transponder has or is connected to at least one sensor for measuring temperature, pressure, moisture, heat flow, electromagnetic radiation.

13. A glazing comprising
a frame, and
an insulating glazing unit according to claim 1 arranged in the frame.

14. The glazing according to claim 13, wherein the frame surrounds end faces of the insulating glazing unit and, at the same time, covers the electronics unit or units in a through-vision direction through the first and second glass panes and enables a top view of the antenna conductor.

15. A system comprising:
an insulating glazing unit according to claim 1, and
an NFC transmission unit and/or reception unit arranged outside the insulating glazing unit for transmitting and/or receiving data from the insulating glazing unit to the outside or from the outside into the insulating glazing unit.

16. The insulating glazing unit according to claim 1, wherein the outer region is filled entirely with the sealing element.

17. The insulating glazing unit according to claim 2, wherein the antenna conductor is a conductor loop or a coil.

18. The insulating glazing unit according to claim 3, wherein the thin electrically conductive structure is a thin metallic or metal structure.

19. The insulating glazing unit according to claim 18, wherein the thin metallic or metal structure is a wire or a print of an electrically conductive paste.

20. The insulating glazing unit according to claim 4, wherein the antenna conductor is arranged on a polymer film, which is a polyethylene terephthalate film and/or polyimide film, with a thickness of 20 μm to 800 μm.
